(19) United States
(12) Patent Application Publication
(10) Pub. No.: US 2023/0103131 A1
(43) Pub. Date: Mar. 30, 2023

(54) CAPTURING AND ANALYZING WEBSITE USER JOURNEYS

(71) Applicant: International Business Machines Corporation, Armonk, NY (US)

(72) Inventors: Steven Edward Atkin, Austin, TX (US); Jeannie Kraus, Stormville, NY (US); Dave McDuff, Ottawa (CA)

(21) Appl. No.: 17/486,191

(22) Filed: Sep. 27, 2021

(51) Int. Cl. H04N 5/278; G06F 16/74; G06F 16/71; G06F 16/9535; G06T 11/20

(52) U.S. Cl. CPC H04N 5/278; G06F 16/743; G06F 16/71; G06F 16/9535; G06T 11/206; H04L 67/14

(57) ABSTRACT

Computer technology for assessing a user's interaction with web content (for example, a session of web surfing). The assessment is performed by computer and includes: (i) detecting interactions of a user with a website during a visit; (ii) based on the interactions, creating a user experience of the visit, wherein the user experience comprises a plurality of images depicting the content viewed by the user; (iii) analyzing the interactions; and (iv) overlaying the analysis of the interactions on the plurality of images depicting the user experience.

### BACKGROUND

The present invention relates generally to the field of website user journeys and in particular to capturing and analyzing these journeys.

A website user journey is a path a user may take, or has already taken, to reach their goal when using a particular website. User journeys are used in designing websites to identify the different ways to enable the user to achieve their informational, educational, recreational and/or commercial objectives in ways that make good tradeoffs between efficiency, reliability, user friendliness (that is enjoyableness of the user's web surfing experience).

The Wikipedia entry for “user journey” (as of 18 Aug. 2021 states in part as follows: “A user journey is the experiences a person has when interacting with something, typically software. This idea is generally used by those involved with user experience design, web design, user-centered design, or anyone else focusing on how users interact with software experiences. It is often used as a shorthand for the overall user experience and set of actions that one can take in software or other virtual experiences. User journeys describe at a high level of detail exactly what steps different users take to complete a specific task within a system, application, or website. This technique shows the current (as-is) user workflow and reveals areas of improvement for the to-be workflow. When documented, this is often referred to as a User Journey Map. User journeys are focused on the user and what they see and what they do, in comparison to the related web design term click path which is just a plain list of the text URLs (uniform resource locators) that are hit when a user follows a particular Journey . . . Conceptual delimitation. The term Customer Journey is also associated with other subject areas, which do not concretely reflect the same benefits, but nevertheless show a connection. Online customer experience primarily refers to the online interface in the technical sense, which aims to optimize the navigation behavior of a website visitor and all interactions. Customer Care is the management of existing customers with the essential part of the customer-oriented service offering and the goal of establishing the longest and most satisfying customer relationship possible. Touchpoint analysis describes all contact points of a buyer with a brand, a product and a service, no matter if the contact is made before, during or after the purchase. Purchase-Funnel is used to optimize the conversion (conversion rate) on the website. So-called conversion paths map the movements of visitors along defined routes (click sequences). Multichannel Marketing refers to the parallel use of several marketing channels to provide services and to build and maintain customer relationships. Problems[.] The difficulties in measuring a customer journey result from the technical specification of the measuring system. This refers to the tracking system currently used in the market via cookies. Developments in the Internet sector show that this system alone will not be able to hold its own in the long term in order to carry out valid data measurements. Additional measurement systems are needed to supplement missing data information. The current challenges in marketing, communication and sales show that a measurement of the customer journey based purely on tracking data is not sufficient. It is a matter of answering cross-channel questions: e.g., how efficient is a company's print campaign compared to its appearance in social media, what role does personal recommendation play in the purchase decision process, etc.? Here, as described above, integrated approaches that cover all activities of a company—whether online or offline—can help. Although a focus on online contact points often has an inviting effect, as these can be easily measured using tracking systems. But a pure “digital journey” only gives a partial picture of the overall process, since many interactions with a brand take place offline.” (footnotes omitted)

### SUMMARY

According to an aspect of the present invention, there is a method, computer program product and/or system that performs the following operations (not necessarily in the following order): (i) receiving a web session data set including information indicative of interactions of a user with a website during a session of computer network based interactions with the website, with the web session data set includes a plurality of visual images that were viewed by the user during the session; (ii) assembling a user website journey video image (UWJVI) including at least some of the plurality of visual images, with the assembly of the video image including: (iii) selecting which visual images and/or portions of visual images to include in the UWIJVI, and (iv) selecting an order for the visual images to be assembled into the UWIJVI; and storing the UWIJVI.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a screenshot view of an image on a page of a snowman making instructional website;

FIG. 4B is a screenshot view of another image from another web page of the snowman making instructional website;

FIG. 4C is a screenshot view of another image from another web page of the snowman making instructional website;

FIG. 4D is a screenshot view of another image from another web page of the snowman making instructional website;

FIG. 4E is a screenshot view of another image from another web page of the snowman making instructional website;

FIG. 4F is a bar chart representing web page visits to the various web pages of the snowman making instructional website;

FIG. 4G is a word cloud generated by the first embodiment system and based on the snowman making instructional website;

FIG. 5 is a flowchart showing a second embodiment of a method according to the present invention;

FIG. 6 is a flowchart showing a third embodiment of a method according to the present invention; and

FIG. 7 is a screenshot generated by an embodiment of the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

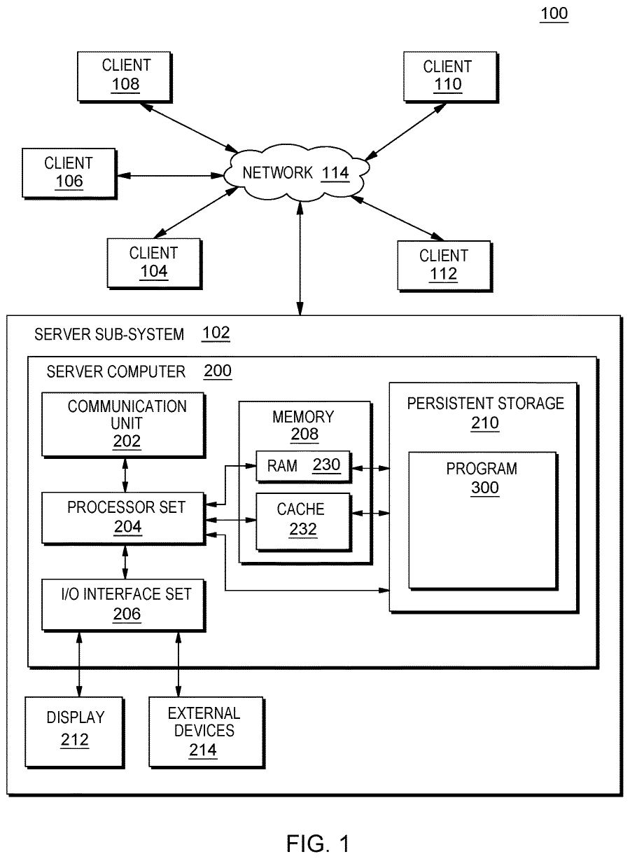

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

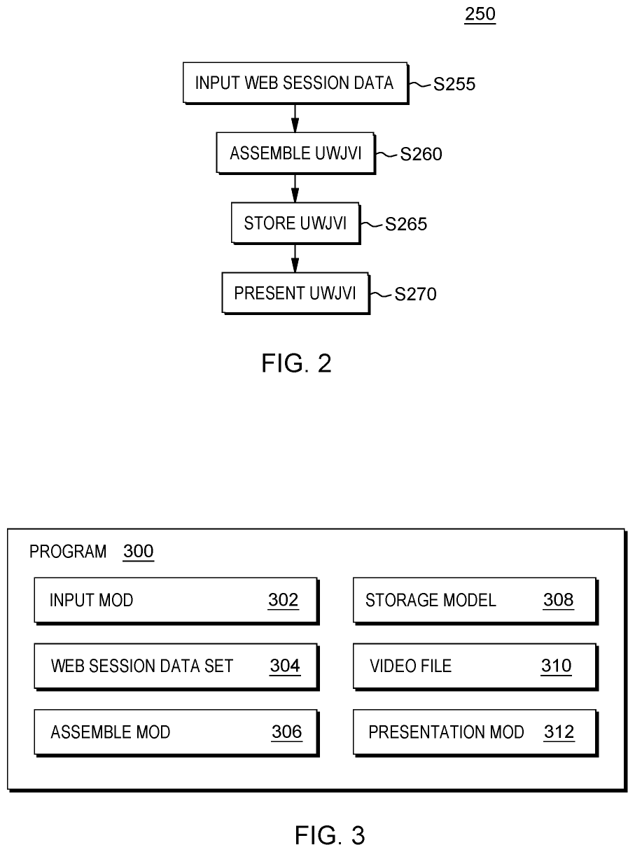

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3. Before discussion of the various steps of the method of flowchart 250 are discussed, it should be understood that the following example is a teaching example with very simple instructions on how to make snowman to show how some of the concepts involved in the present invention work. Some, probably more realistic, potentially commercial applications of this technology include, but are not limited to: (i) video helped to determine navigation issues; uncover no search results found issues; missing content issues; (ii) identify broken link issues; and (iii) improper provisioning of various types of computer services and/or microservices.

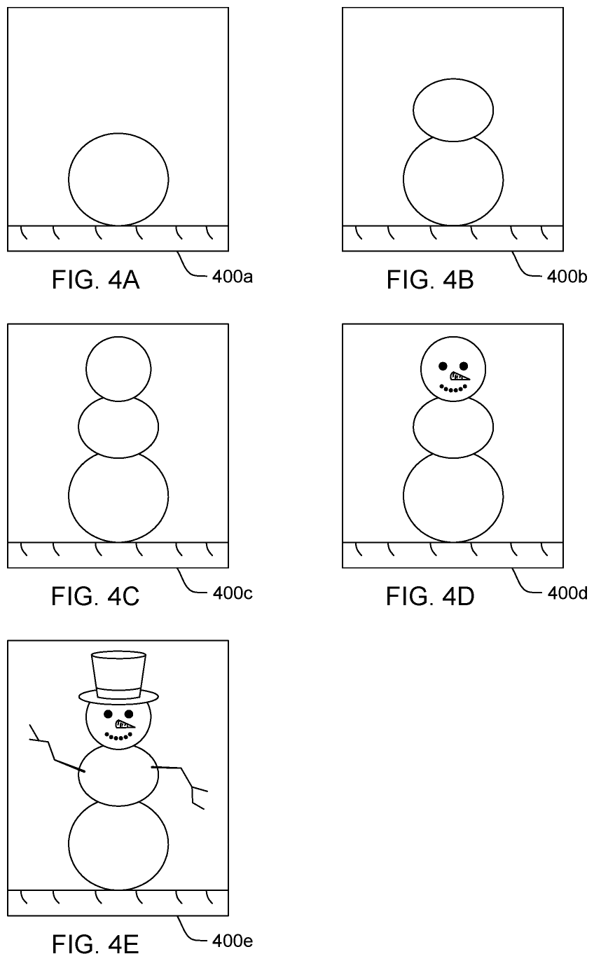

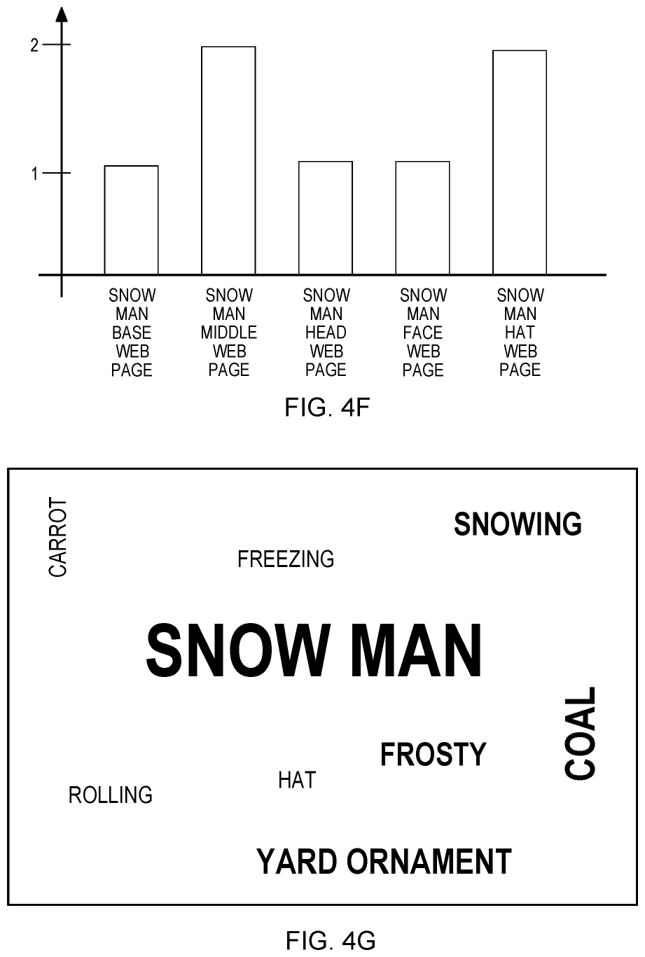

Processing begins at operation S255, where input module (“mod”) 302 receives web session data set 304 including information indicative of interactions of a user with a website during a session of computer network based interactions with the website, with the web session data set includes a plurality of visual images that were viewed by the user during the session. The various visual images of the plurality of visual images may variously take the following forms: still image, video image, animated video image, video image taken from real life, x-ray image and/or weather forecasting image. In this example, data set 304 includes three still images 400a, 400b, 400c, 400d, 400e as respectively shown in FIGS. 4A, 4B, 4C, 4D and 4E. In this example, the images are taken from a website that includes step by step instructions on how to build a snowman. In this example, the user who experienced the website journey is the user of client subsystem 104. The various images experienced on the journey came from various server computers at the following client subsystems 106, 108, 110 and 112.

Processing proceeds to operation S260, where assemble mod 306 assembles a user website journey video image (UWJVI). In this example, the UWJVI includes all five video images 400a to 400e. The assembly of the video image includes the following sub-operations: (i) selecting which visual images and/or portions of visual images to include in the UWIJVI (in this example, all of them), and (ii) selecting an order for the visual images to be assembled into the UWIJVI. In this case the order of the constituent images within the UWJVI is as follows: 400a, 400b, 400c, 400d, 400e. In this example, each of the five (5) constituent images is shown for one (1) minute, meaning the UWJVI is 5 minutes long.

Processing proceeds to operation S265, where storage mod 308 stores the UWIJVI as video file 310. In this example, the UWJVI is stored as a *.avi video format file in this teaching example. The best format to use for the video files may vary with the particular application. For example, in some embodiments, the *.mp4 format is used to store and communicate video files. This is because MP4 is a generally used and widely accepted format for video files. Many computer resource libraries will create MP4 files by default.

Processing proceeds to operation S270, where presentation mod 312 presents the UWIJVI as a video presentation to one or more viewers. In this example, the five minute video is presented to the user of subsystem 104, which is the same user that experienced the website journey in the first place.

In some embodiments, program 300 also generates, by machine logic, explanatory text based on the web session data set, with the explanatory text relating to various aspects of the interactions of the user with the website; and overlays the explanatory text as captioning type text into the visual presentation of the UWIJVI.

In some embodiments, program 300 also creates, by machine logic, a bar-chart that illustrates the overall user journey type metrics associated with the session. An example of this is shown in FIG. 4F. In some embodiments, Program 300 also creates, by machine logic, a human understandable weighted-word cloud image that illustrates the overall user journey related natural language words associated with the session. An example of this is shown in FIG. 4G.

### III. Further Comments and/or Embodiments

Some embodiments of the present invention recognize the following facts, potential problems and/or potential areas for improvement with respect to the current state of the art: (i) many teams use a basic web analytics package to collect user visits, but need to be supplemented by an advanced analytic capabilities to allow for user session analysis; (ii) in the market there are a few popular advanced analytic packages, which typically have some capability to play back a user's session, with certain constraints and/or limitations; (iii) some conventional software platforms only do sampling and lack the ability to look at specific user journeys/sessions to fully explain issues to human users; (iv) some conventional technology is also limited in that it must have a continuous connection to a backend server to completely capture events and is constrained to a small period of time upon which data can be retrieved; (v) some conventional technology requires that the complete DOM (document object model) be rendered and available before events can be fully captured; and/or (vi) the conventional technology mentioned in the foregoing item on this list can lose information at certain junctures in the processing under certain conditions (for example, rapid surfing through many web pages by the user on her website journey).

Some embodiments of the present invention recognize the following facts, potential problems and/or potential areas for improvement with respect to the current state of the art: (i) capturing and presenting an easily consumable analysis of the visitor journey is required and these technologies cannot easily summarize the journey and the information cannot be easily shared, annotated and worked on collaboratively; and/or (ii) what is needed is a lightweight approach to capturing user journey information that does not: (a) require continuous server connections, (b) can be easily shared, (c) provides a complete synopsis of their journey, (d) is triggered by one or more quality measures, (e) only requires a basic web analytics package, and/or (f) complies with governmental and/or contractually-based regulatory data privacy requirements.

Some embodiments of the present invention may include one, or more, of the following operations, features, characteristics and/or advantages: (i) solely relies on the data provided by a basic web analytics package; (ii) the data that is required includes site/page visited, click events on the page, date/time the page was visited, user tracking ID (identification), and their origination along with geography/languages; and/or (iii) enables the definition of one more quality triggers such as Net Promoter Score for NPS to drive the analysis and capturing of user session information in a consumable way. To further explain item (iii) on the foregoing list, NPS is a cross industry measurement system for measuring client and/or user satisfaction with the company's web presence, such as their web pages, chatbots, user interfaces and other web based resources.

Some embodiments of the present invention may include one, or more, of the following operations, features, characteristics and/or advantages: (i) reconstructs an entire user journey as a video playback that presents the screens and events that the user visited and performed; (ii) the video playback contains an upfront synopsis that categorizes all the sites visited, time spent, date ranges, geography/languages, KPIs (key performance indicators) (such as search queries, NPS scores, client details, when surveys are triggered, click through rate, cyclic repeat visits, and purpose of the journey); (iii) the video playback then presents each page visited in date/time sequence; (iv) alongside the visual representation of the page visited, closed captions of relevant data about the page are displayed along with what the user did on the page (for example, page URL, referral URL, click event, session duration, product family, entitled content, and/or NPS survey trigger data); and/or (v) while the video is being constructed, no PI (personal information) data is collected and encoded into the video to enable safe sharing with others.

Some embodiments of the present invention may include one, or more, of the following operations, features, characteristics and/or advantages: (i) does not require any new instrumentation to web pages over standard web analytics; (ii) provides user journey summaries and data insights about the user session; (iii) can be easily shared without worrying about PI and data privacy issues; (iv) does not require specialized viewers and can be viewed offline; (v) provides annotations about each visited page and supports additional user annotations; (vi) does not require additional licenses or extra access to web analytics; and/or (vii) is highly accessible through the use of closed captioning.

According to some embodiments, the present invention takes as input, the Google Analytics visited web sites and user actions from a universal profile ID (identification) that was stored in a client side cookie.

Some embodiments of the present invention may include one, or more, of the following operations, features, characteristics and/or advantages pertaining to analytics and user journey score: (i) analytics are collected for all the visited sites, specifically each visited site is categorized and the total number of page visits and durations are calculated; (ii) a user journey score is calculated that includes the types of sites visited and experience measures such as search quality, ease of navigation, and consistency of information architecture models across the sites; (iii) a bar-chart is created that illustrates the overall journey metrics; (iv) a weighted word-cloud is created based upon the sites in the user's journey; (v) natural language processing is performed on each page to extract keywords and intents; (vi) a weighting algorithm is applied to the frequencies of the keywords and intents that factors in the duration that the page was accessed and the frequency of the number of times the page was visited during the journey; and/or (vii) generates insights with confidence scores that reveal the underlying intent of the user during their journey to the sites.

Some embodiments of the present invention may include one, or more, of the following operations, features, characteristics and/or advantages pertaining to a user journey movie: (i) starts a headless web browser and visits each website and performs any user actions to simulate the actual user experience; (ii) takes a screenshot of each web page visited and action performed; (iii) creates a closed-caption that indicates the URL, timestamp, duration and events that occurred on the web page and the referral page; (iv) locates the specific page when the NPS survey was displayed and score input; and/or (v) constructs a video of all the screen shots and associated captions.

Some embodiments of the present invention may include one, or more, of the following operations, features, characteristics and/or advantages pertaining to the journey insights score: (i) the score evaluates the measures of success of any one visitor's journey through their website session(s); (ii) the score gives insight as to the satisfaction and certainty of task completion; (iii) gives insights into elements of the journey that need attention (for example, client feedback as reported in NPS surveys); and/or (iv) the NPS score doesn't always reflect that of the entire journey and is potentially measuring other things.

Some embodiments of the present invention may include one, or more, of the following operations, features, characteristics and/or advantages of the known journey factors (metrics): (i) the % of site visits under three (3) seconds is known; (ii) the % of search terms used and its overlap with the word cloud is known; (iii) the weighting of the keywords on duration of visits and % time engaged is known; (iv) the classification of the pages visited is known; (v) the # of visits per page/page type is known; (vi) the total duration per page type is known; (vii) how many URLs were “repeated” in the session is known; (viii) the “cycles” (number of times people repeat a specific page visit pattern) can be determined; (ix) the in-page event activities (that is, clicks on button, etc.) is known; (x) the user to their Medallia Feedback (verbatim and score) can be matched; and/or (xi) the per page engagement rates in the session is known.

Some embodiments of the present invention may include one, or more, of the following operations, features, characteristics and/or advantages pertaining to insight signals: (i) visits above three (3) seconds are good (that is: lower is a worse experience)—MEASURED IN PERCENT (visits); (ii) overlap between search terms and word cloud is low (that is, lower overlap is bad)—MEASURED IN PERCENT (intersect); (iii) “in-page” engagement (that is, clicks), (low engagement is bad)—MEASURED IN CLICKS PER PAGE, EXPRESSED AS A PERCENT (engagement_rate); (iv) if the intent classification of the search terms do not align with the classification of the resulting page visits, then the user is not likely to have completed their task—MEASURED IN PERCENT OVERLAP (intent_classification); (v) % of journey that has no duplicate page visits—MEASURED BY PERCENT NOT REPEATED PAGE VIEWS OF THE TOTAL VIEWS (non_repeated_page_view_counts); (vi) if the NPS score is low, then the journey represents that score. (that is, a bad journey)—MEASURED BY NPS VALUE (NPS); and/or (vii) total journey duration (higher is worse)—MEASURE CATEGORY SCORE (journey_duration_score).

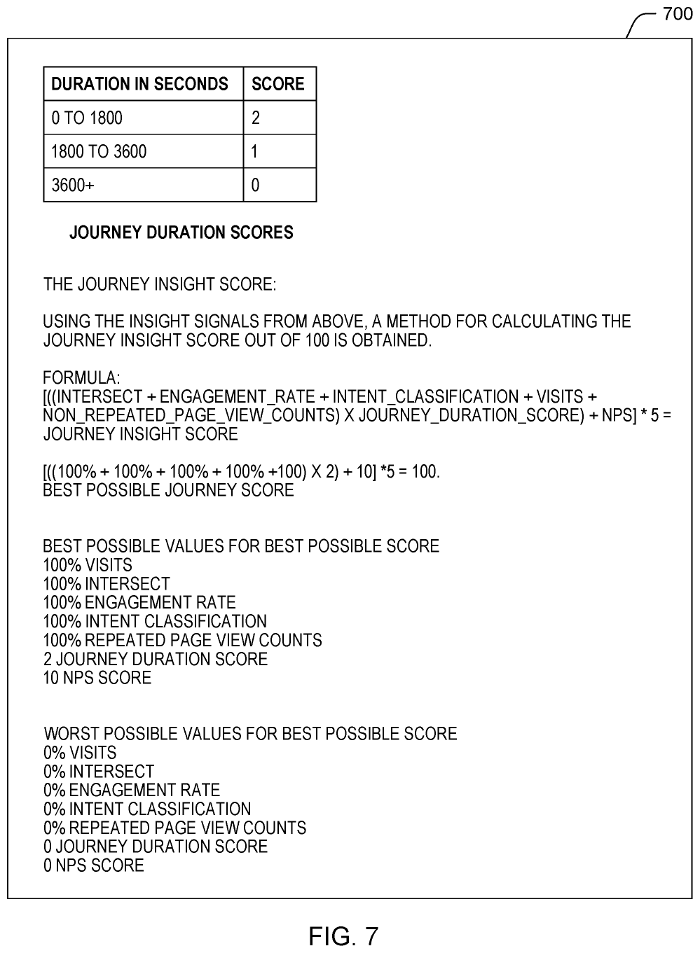

As shown in FIG. 7, screenshot 700 shows a table for scores mapped against journey duration and also other relevant information relating to the user's website journey.

According to embodiments of the present invention, there is a method of assessing user interaction with web content comprising: (i) detecting interactions of a user with a website during a visit; (ii) based on the interactions, creating a user experience of the visit, wherein the user experience comprises a plurality of images depicting the content viewed by the user; (iii) analyzing the interactions; and (iv) overlaying the analysis of the interactions on the plurality of images depicting the user experience.

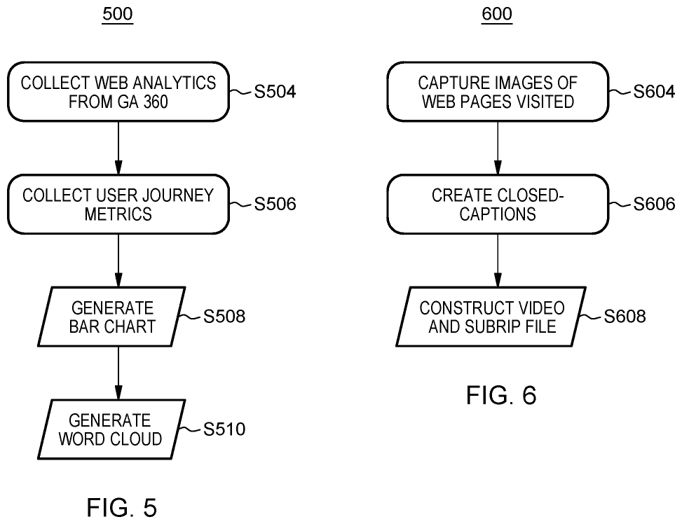

As shown in FIG. 5, flowchart 500 shows a method relating to analytics and user journey score. This method includes the following operations (with process flow among and between the operations as shown by arrows in FIG. 5): collect web analytics operation S504; collect user journey metrics operation S506; generate bar chart operation S508; and generate word cloud operation S510. As shown in FIG. 6, flowchart 600 shows a method of making a user journey movie. This method includes the following operations (with process flow among and between the operations as shown by arrows in FIG. 6): capture images of web pages visited block S604; create closed-captions block S606; and construct video and SubRip file S608.

Some embodiments of the present invention may include one, or more, of the following operations, features, characteristics and/or advantages: (i) uses the content contained within the visited pages to extract intent or insights; (ii) uses generalized web metrics to classify and identify intent through the categorization of visited pages; (iii) generates a journey success score; (iv) is not required to perform any type of path analysis or aggregated analysis to determine visitor intents and journey scores; (v) it is not required to provide any type of recommendations or suggestions about using traversed paths to recommend items that might be of interest to a consumer; (vi) it is not required to utilize tracking eye movements to determine which portion of a web page is more interesting to a user; and/or (vii) it is not required to address issues related to problematic web elements on a page, such as non-functional buttons, pages that take a long-time to load, images missing, and broken links and other interactive elements that are performance sensitive.

Some embodiments of the present invention may include one, or more, of the following operations, features, characteristics and/or advantages: (i) focused on generating insights of web journeys based upon the content contained in the pages visited; (ii) the content analyzed from the pages is weighted by the frequency of use and level of engagement with the visited content; (iii) uses client journey scores for assessing how successful a client was in their journey; (iv) uses the content itself that is visited in the journey to determine the intent of the user; and/or (v) generates insights that explains the intent of the journey and the level of success in a client's interaction with visited web pages.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
receiving a web session data set including information indicative of interactions of a user with a website during a session of computer network based interactions with the website, with the web session data set including a plurality of visual images that were viewed by the user during the session;
assembling a user website journey video image (UWJVI) including at least some of the plurality of visual images, with the assembly of the video image including:
selecting which visual images and/or portions of visual images to include in the UWIJVI, and
selecting an order for the visual images to be assembled into the UWIJVI; and
storing the UWIJVI;
wherein the selection of which visual images to include in the UWIJVI is based at least in part on information received from a cross industry measurement system for measuring client and/or user satisfaction with a company's web presence.

2. The CIM of claim 1 further comprising:
presenting the UWIJVI as a video presentation to one or more viewers.

3. The CIM of claim 1 further comprising:
generating, by machine logic, explanatory text based on the web session data set, with the explanatory text relating to various aspects of the interactions of the user with the website; and
overlaying the explanatory text as captioning type text into the visual presentation of the UWIJVI.

4. The CIM of claim 1 wherein the explanatory text overlaid into the UWJVI includes website user journey metric values presented in human understandable form and format.

5. The CIM of claim 1 further comprising:
creating, by machine logic, a bar-chart that illustrates the overall user journey type metrics associated with the session.

6. The CIM of claim 1
wherein the cross industry measurement system is a quality trigger called Net Promoter Score.

7. A computer program product (CPP) comprising:
a set of storage device(s); and
computer code stored collectively in the set of storage device(s), with the computer code including data and instructions to cause a processor(s) set to perform at least the following operations:
receiving a web session data set including information indicative of interactions of a user with a website during a session of computer network based interactions with the website, with the web session data set includes a plurality of visual images that were viewed by the user during the session,
assembling a user website journey video image (UWJVI) including at least some of the plurality of visual images, with the assembly of the video image including:
selecting which visual images and/or portions of visual images to include in the UWIJVI, and
selecting an order for the visual images to be assembled into the UWIJVI, and
storing the UWIJVI;
wherein the selection of which visual images to include in the UWIJVI is based at least in part on information received from a cross industry measurement system for measuring client and/or user satisfaction with a company's web presence.

8. The CPP of claim 7 wherein the computer code further includes instructions for causing the processor(s) set to perform the following operation(s):
presenting the UWIJVI as a video presentation to one or more viewers.

9. The CPP of claim 7 wherein the computer code further includes instructions for causing the processor(s) set to perform the following operation(s):
generating, by machine logic, explanatory text based on the web session data set, with the explanatory text relating to various aspects of the interactions of the user with the website; and
overlaying the explanatory text as captioning type text into the visual presentation of the UWIJVI.

10. The CPP of claim 7 wherein the explanatory text overlaid into the UWJVI includes website user journey metric values presented in human understandable form and format.

11. The CPP of claim 7 wherein the computer code further includes instructions for causing the processor(s) set to perform the following operation(s):
creating, by machine logic, a bar-chart that illustrates the overall user journey type metrics associated with the session.

12. The CPP of claim 7 wherein the cross industry measurement system is a quality trigger called Net Promoter Score.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving a web session data set including information indicative of interactions of a user with a website during a session of computer network based interactions with the website, with the web session data set includes a plurality of visual images that were viewed by the user during the session,
assembling a user website journey video image (UWJVI) including at least some of the plurality of visual images, with the assembly of the video image including:
selecting which visual images and/or portions of visual images to include in the UWIJVI, and
selecting an order for the visual images to be assembled into the UWIJVI, and
storing the UWIJVI;
wherein the selection of which visual images to include in the UWIJVI is based at least in part on information received from a cross industry measurement system for measuring client and/or user satisfaction with a company's web presence.

14. The CS of claim 13 wherein the computer code further includes instructions for causing the processor(s) set to perform the following operation(s):
presenting the UWIJVI as a video presentation to one or more viewers.

15. The CS of claim 13 wherein the computer code further includes instructions for causing the processor(s) set to perform the following operation(s):
generating, by machine logic, explanatory text based on the web session data set, with the explanatory text relating to various aspects of the interactions of the user with the website; and
overlaying the explanatory text as captioning type text into the visual presentation of the UWIJVI.

16. The CS of claim 13 wherein the explanatory text overlaid into the UWJVI includes website user journey metric values presented in human understandable form and format.

17. The CS of claim 13 wherein the computer code further includes instructions for causing the processor(s) set to perform the following operation(s):
creating, by machine logic, a bar-chart that illustrates the overall user journey type metrics associated with the session.

18. The CS of claim 13 wherein the cross industry measurement system is a quality trigger called Net Promoter Score.
